(19) United States
(12) Patent Application Publication
(10) Pub. No.: US 2022/0039399 A1
(43) Pub. Date: Feb. 10, 2022

(54) Dough Strip Shaping Member Having A Cutting Device

(71) Applicant: König Maschinen Gesellschaft m.b.H., Graz (AT)

(72) Inventors: Eduard Rauch, St. Margarethen (AT); Markus Radl, Fürstenfeld (AT)

(21) Appl. No.: 17/275,240

(22) PCT Filed: Sep. 11, 2019
(86) PCT No.: PCT/AT2019/060294

§ 371 Date: Mar. 11, 2021

(30) Foreign Application Priority Data
Sep. 11, 2018 (AT) A 50771/2018

(51) Int. Cl. A21C 3/10; A21C 3/02; A21C 11/10; B26D 7/26

(52) U.S. Cl. CPC A21C 3/10; A21C 3/02; B26D 2210/02; B26D 7/2635; A21C 11/10

(57) ABSTRACT

The present teaching relates to a device for shaping multiple dough strip strands including a dough feeding device by means of which dough can be introduced into the device. It has at least two shaping rolls that can be rotated about the axes thereof, at least one discharge roll that can be rotated about the axis thereof, and at least one drive by means of which the shaping rolls and/or the discharge roll can be driven about their axes. The axes of the shaping rolls and of the discharge roll are arranged parallel to and at a distance from each other and a dough chamber is formed between the shaping rolls and the discharge roll. The device has two side covers, which delimit the dough chamber laterally, in particular at the end of the shaping rolls and the discharge roll.

### TECHNICAL FIELD

The present teaching relates to a device for shaping several dough strips.

### BACKGROUND

Dough strip shaping members for shaping dough loads into dough strips are widely known in the prior art. Systems known in the prior art consist primarily of feeding devices, pre-portioning devices which reduce the dough load for reshaping, and dough strip shaping units.

These dough strip shapers consist of at least two or more rolls with uniform or varying diameters. The rolls can also be produced with various surfaces or profiles. The length of the rolls primarily determines the width of the dough strips to be produced. For baked goods, these dough strips are of a single section or multiple lengthwise and width-wise sections, depending on the product. For lengthwise cutting, that is, for dividing the dough strip into several dough strip strands along its width, two methods are known in the art. In the first, the edges of the dough strip are cut, so that a major portion of the dough strip is accrued as waste, and in the second method the dough strip is cut without edge removal, which has the advantage that no edge waste accrues, and allows a saving of up to 15% of the mass that is to be processed.

In known devices and methods for cutting the dough strip with edge portion, the dough strip is produced in the dough strip shaper and, on leaving the dough strip shaper or at other points of the dough strip apparatus, the dough strip, according to the shape, is cut lengthwise into one or more strips or dough strip strands. This cutting is done using a disc cutter, punching die, water jet or the like. With systems of this type, to obtain uniform dough strip strands, a certain edge (10-15%) is cut off.

With known devices and methods for cutting the dough strip without edge cutting, the dough strip is produced in the dough strip shaper and, after leaving the dough strip shaper or at other points in the dough strip apparatus, is cut, wherein, in order to obtain uniform cross-sections, it is necessary to perform the cutting in the flow direction in a so-called calibration unit. To keep the cross-section uniform, extensive lateral guides are necessary which, to avoid dough adhering, must move along with the cutting device or must be provided with dividing means.

The disadvantage of systems known from the prior art, therefore, is that a large edge portion of the dough Is lost and/or an additional module or additional station in the dough strip apparatus becomes necessary, appreciably increasing the complexity, maintenance, cleaning, and costs.

### SUMMARY

It is thus one object of the present teaching to provide a device which makes possible lengthwise cutting of the dough strip that is economical and simple to operate, allows a high degree of precision in cutting the dough strip strands, and produces little or no wasted dough.

This object is fulfilled by the identifying features of the present disclosure, wherein it is foreseen that the device comprises a cutting roll, which in particular is power-operated and is arranged inside the dough chamber,
wherein one of the shaping rolls or the cutting roll with the discharge roll are arranged at a distance from one another so that dough can be shaped, between one of the shaping rolls or the cutting roll, to a defined thickness as a shaped dough strip,
wherein the cutting roll comprises a number of cutting blades, particularly disc-shaped, which extend to the outer perimeter of the discharge roll and wherein the cutting roll is arranged along with the discharge roll in the area of the outlet of the dough chamber in such a way that the cutting blade divides the dough strip shaped in the dough chamber along the width of the dough strip into a number of dough strip strands.

As a result of the inventive device, it is possible to execute the lengthwise cuts directly in the dough strip calibration unit or in the dough strip shaper, further making stations in the dough strip apparatus superfluous and reducing the length of the dough strip apparatus and the space required for it. No border section and thus no waste occurs, and thus profit is increased, and no foodstuffs are wasted.

In addition, the dough strip is fed through the cutting roll and the discharge roll as well as the lateral coverings during cutting on four sides, resulting in a uniform shape and width and thus increased precision of the dough strip strands.

Particularly advantageous embodiments of the present teaching are defined in greater detail by the features of the dependent claims.

Improved quality of cutting is achieved in that the discharge roll is configured as a counter-roll for the cutting roll, wherein the cutting blades of the cutting roll extend to the discharge roll, wherein the cutting blades in particular comprise a greater cutting depth than the shaped dough strip, so that the dough strip undergoes no reshaping between the discharge roll and the cutting roll.

The thickness of the dough strip can advantageously be adjusted if the device includes a pivot device, wherein a number of the shaping rolls, in particular all shaping rolls that, each seen on a common side of the dough chamber with respect to the thickness of the dough strip, are arranged on the same side, and/or the discharge rolls are connected with the pivot device and can be pivoted by means of the pivot device in the direction of the thickness of the dough strip, wherein the distance of the axes of the shaping rolls and/or of the discharge roll that are connected with the pivot device can be adjusted to the axes of at least one, in particular of all, of the respective other shaping rolls not connected with the pivot device and/or of the discharge rolls and in this way the thickness of the dough strip can be modified and/or pre-set.

The thickness of the dough strip can advantageously be adjusted if the device includes a pivot device, wherein a number of the shaping rolls, in particular all shaping rolls that, each seen on a common side of the dough chamber with respect to the thickness of the dough strip, are arranged on the same side, and/or the discharge rolls are connected with the pivot device and can be pivoted by means of the pivot device in the direction of the thickness of the dough strip, wherein the distance of the axes of the shaping rolls and/or of the discharge roll that are connected with the pivot device can be adjusted to the axes of at least one, in particular of all, of the respective other shaping roll not connected with the pivot device and/or of the discharge roll and in this way the thickness of the dough strip can be modified and/or pre-set.

It can advantageously be foreseen that the device, in particular the pivot element, comprises a pivot drive, particularly a hydraulic or pneumatic or electrical or electromechanical pivot drive, wherein the pivot drive is arranged and configured in such a way that a number of the shaping rolls, particularly all shaping rolls that, each seen on a common side of the dough chamber with respect to the thickness of the dough strip, are arranged on the same side and/or the discharge roll in the direction of the thickness of the dough strip can be powered oscillating about a neutral point, so that the distance of the axes of the shaping rolls and/or of the discharge roll, which can be moved in an oscillating manner by the pivot drive, from the axes of at least one, particularly of all, of the respective other shaping rolls not powerable by the pivot drive and/or from the axis of the discharge roll oscillating in the dough production process are displaced by a preset distance. Owing to the oscillation movement of the individual rolls, the dough quality is improved, and a homogeneous dough strip is produced, and thus the weight tolerance of the dough pieces is considerably reduced. In addition, the removal of dough from individual rolls is facilitated.

The distance of the shaping rolls from one another can alternatively be easily modified wherein the pivot element includes a control element, which is preferably lengthwise adjustable, in particular a hydraulic or pneumatic cylinder or electromechanical actuators, wherein the pivot drive comprises an eccentric mechanism, powered by a motor, wherein the placement element is connected at one end with the pivot lever and at the other end with the eccentric mechanism, wherein the pivot lever, with the motor powered, can be pivoted about the pivot axis by the eccentric mechanism and the control element, oscillating about a neutral point.

Owing to the displacement by means of the control element, a wider displacement distance is possible. The lateral wall or the cover of the device can be folded open and the shaping rolls can then easily be removed and cleaned in their unfolded state.

To allow simple removal and displacement of the cutting rolls, it can be foreseen that the cutting roll is arranged on a displacement device, wherein the distance and/or the pressure force of the cutting roll on the discharge roll can be adjusted by means of the displacement device, wherein the displacement device in particular is configured as a pivot arm that is displaceable about an axis, and on which the cutting roll is arranged.

The lateral edges of the cut dough strip strands are improved in that the discharge roll and/or the cutting roll comprise two lateral walls, each of which is arranged in the area at the end of the discharge roll and/or of the cutting roll, wherein the lateral walls are arranged and configured in such a way that, upon cutting the dough strip with the cutting roll, misshaping and deflection of the dough strip are prevented.

To prevent accumulation of the dough, it can be arranged that the device includes a number of scrapers, wherein the scrapers each are contiguous with the periphery of the shaping roll, wherein dough from the periphery of the respective shaping roll can be removed by means of the scrapers or wherein the device includes a number of milling devices and/or a number of spraying elements, wherein the milling devices and/or the spray elements are arranged in the device in such a way as to hinder accumulation or sticking of dough on the surfaces of the device that come in contact with the dough.

To prevent unwanted pressure forces and overflowing of the dough feeder device, it can be foreseen that the dough feeder device includes a filler funnel and at least one filler status sensor, wherein the filler status of the dough feeder device, in particular of the filler funnel, can be read by means of the filler status sensor.

It can advantageously be provided that the device includes a number of drives, wherein the shaping rolls and/or the discharge roll in each case can be powered together or separately, preferably at different rotation speeds, or that the device includes two drives, wherein the shaping rolls that, each seen on a common side of the dough chamber with respect to the thickness of the dough strip, are arranged on the same side, are each powered together with one of the two drives and, in particular, are connected with one another by gears.

A preferred configuration of the device is achieved if the shaping rolls and/or discharge roll and/or cutting roll have different profiles, wherein in particular the shaping rolls comprise a profiled periphery and the discharge roll and cutting roll are of smooth configuration.

For easy cleaning and exchange of the cutting roll and/or the blades, it can be foreseen that the cutting roll is arranged replaceably on the device.

To allow the thickness of the dough strip produced by the device to be adjusted automatically and/or depending on the dough feeder, it can be foreseen that the control element, particularly the hydraulic or pneumatic cylinder or the linear elements or the spindle drive, comprises a sensor system by which the current length of the control element can be determined, wherein in particular by means of the sensors the length of the control element and thus the thickness of the dough strip can be adjusted on the basis of previously determined or recorded weights of the dough pieces.

Additional advantages and configurations of the present teaching can be seen from the description and the attached drawings.

### BRIEF DESCRIPTION OF THE DRAWINGS

The present teaching is schematically depicted hereinafter by means of particularly advantageous embodiments, which are not, however, to be understood as restrictive, and shown schematically in the drawings and described by way of example with reference to said drawings.

FIG. 1 shows a first embodiment of an inventive device in sectional view.

FIG. 2 shows an embodiment of the present teaching with six rolls.

FIG. 3 shows an additional embodiment of the inventive device with dough feeder attachment.

FIG. 4 shows a view of the device seen in an explosion drawing according to FIG. 3.

FIG. 5 shows an alternative embodiment of the present teaching with slightly adjusted dough strip thickness.

FIG. 6 shows a detail view of the eccentric mechanism of the oscillation unit.

FIG. 7 shows a lateral view of the device with large adjusted dough strip thickness.

### DETAILED DESCRIPTION

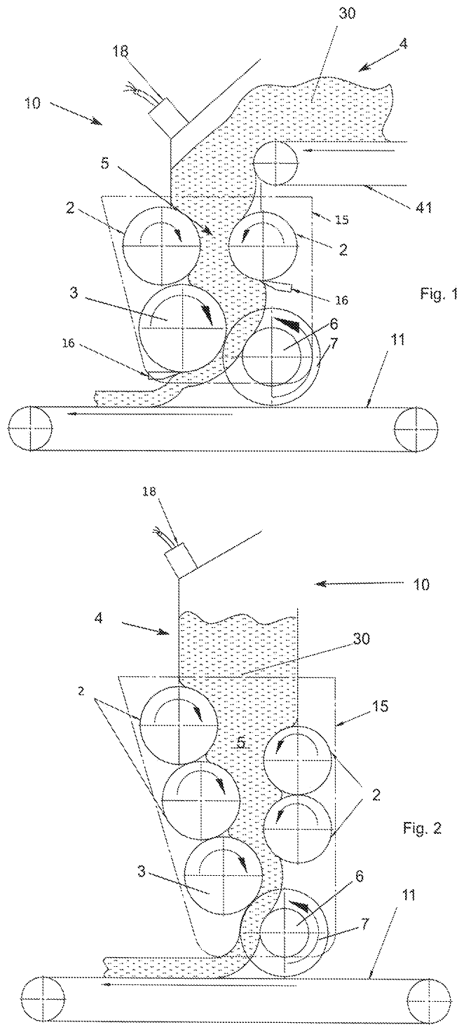

FIG. 1 depicts an embodiment of the device 10 for shaping several dough strip strands in a simplified section view. The device 10 includes four rolls, each of which can be rotated by a drive 21 about its axis, two shaping rolls 2, a discharge roll 3 and a cutting roll 6. Dough 30 is fed by way of a dough feeding device 4, by means of a conveyor belt 41 in the flow direction of the dough above the two first shaping rolls 2.

The axes of the shaping rolls 2 and of the discharge roll 3 are arranged parallel to one another at a distance and, between the shaping rolls 2 and the discharge roll 3, configure a dough chamber 5 in which the dough 30 is worked and shaped as a dough strip. In addition, the device 10 includes two lateral coverings 15, which are contiguous with the front end of the shaping rolls 2 and the discharge roll 3 and laterally delimit the dough chamber 5 and reinforce it against the surroundings. The dough 30 is drawn into the dough chamber 5 through the mirror-inverted rotation of the first two shaping rolls 2, worked between the shaping rolls 2, possible dough pieces are made uniform and thus a continuous endless dough strip is produced.

The device 10 includes a cutting roll 6, which is arranged inside the dough chamber 5 at its outlet. The axis of the cutting roll 6 is arranged parallel to the axes of the shaping rolls 2 and the discharge roll 3. The cutting roll 6 comprises a number of disc-shaped cutting knives 7, which extend from the periphery of the cutting roll 6 in the direction of the discharge roll 3 all the way to its periphery. The dough strip is removed from the dough chamber 5 between the discharge roll and the cutting roll 6, wherein the dough strip is cut into a number of dough strip strands corresponding to the number of cutting blades 7. The width of the dough strip strands is determined by the distance between the cutting blades 7 and the distance of the cutting blades 7 situated close on the cutting roll 6 in the lengthwise direction of the front end of the cutting roll 6. The thickness of the dough strip is determined in the embodiment shown in FIG. 1 by the distance of the discharge roll 3 with the cutting roll 6. The discharge roll 3 in this embodiment forms a counter-roll for the cutting roll 6, with which the cutting blades 7 are contiguous and pressured.

At the outlet of the dough chamber 5, the dough strips cut by the cutting roll 6 are transported by a dough delivery device 11, which is configured as a transport belt, out of the device 10 and into the dough strip appliance for further processing.

Depicted in FIG. 2 in a schematic section view is an additional embodiment of the inventive device 10. The device 10 includes four shaping rolls 2. The dough 30 is conveyed by way of the dough feeding device 4 through a dough funnel by gravitational force to the first two shaping rolls 2 and drawn between them into the dough chamber 5. Between the shaping rolls 2, the dough strip can be worked and made uniform, depending on the type of dough, and shaped as a dough strip with defined thickness between the final shaping rolls 2, that is, those situated closest to the outlet of the dough chamber 5, and shaped to the discharge roll 3. The dough strip shaped in this way is then cut into dough strip strands with defined width between the discharge roll 3 and the cutting roll 6 and discharged from the device 10 by a dough ejecting device 11. The dough strip in this embodiment is no longer reshaped between the cutting roll 6 and the discharge roll 3.

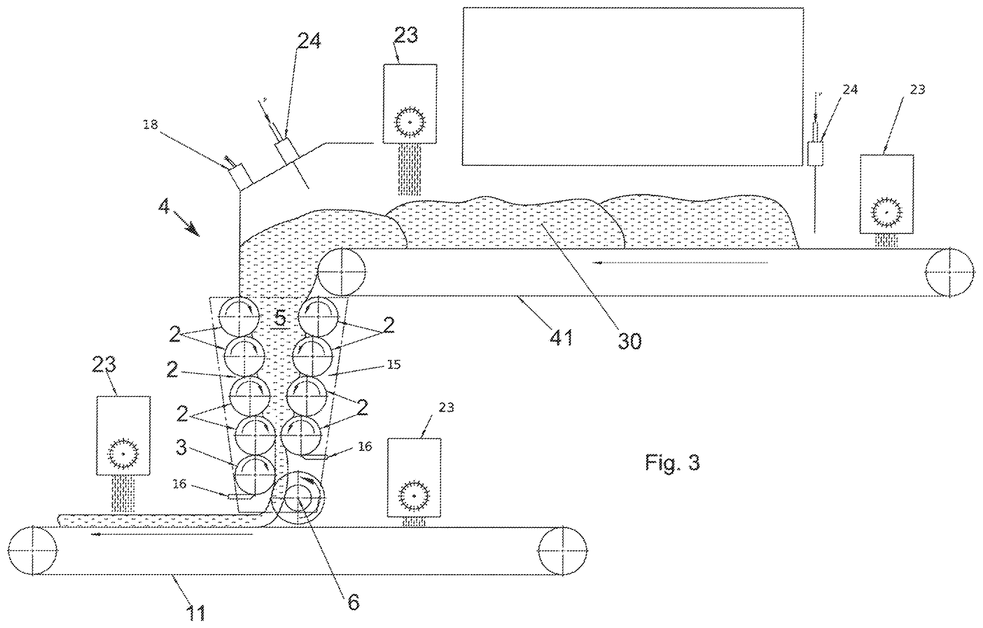

FIG. 3 depicts an additional embodiment of the device 10 in a schematic lateral view. The device 10 comprises eight shaping rolls 2, arranged in two rows with four shaping rolls 2 each bordering the dough chamber 5 laterally or arranged on the same side with respect to the thickness of the dough strip. The shaping rolls 2 along with their periphery are contiguous with one another and have the same diameter. The two rows of shaping rolls 2 are arranged with respect to one another in funnel shape, so that in each case the distance between the axes of the shaping rolls 2 arranged in each case at the same height in the dough chamber 5 are tapering in the direction from the entrance of the dough chamber 5 to the outlet. The thickness of the dough strip is then determined between the final two shaping rolls 2 which are arranged closest to the outlet of the dough chamber 5. The dough strip is then fed between the periphery of the discharge roll 3 and the cutting roll 6 and there cut into a number of dough strip strands and expelled from the device 10 by means of a conveyor belt or a spreading apparatus in which the dough strip strands are separated from one another.

To prevent sticking of the dough 30, especially sticky dough with high water content, on the conveyor belts 41, transport rolls and rolls, so-called optional severing means can be employed. The severing means, flour, water, and the like, can for example be applied by a number of milling devices 23 and/or a number of spray elements 24. The milling devices 23 provide, on the belts and surfaces of the dough strips, a flour-film, which adheres to them and separates the dough strip or the dough from the parts of the device 10. Thereafter, scrapers 16 are arranged on the final dough strip shaping rolls in order to prevent possible adherences or to separate or scrape the dough more easily from them. If no separating flour is desired in certain doughs, for example, gluten-free doughs, then a separating film of water or oil can replace the flour-film by means of the spray elements 24.

As shown in FIGS. 1 and 3, the device 10 can include a number of scrapers 16, which are each contiguous with the periphery of one or more of the shaping rolls 2, in each case the final two shaping rolls 2 in the conveyance direction of the dough. The dough is lifted off by the scrapers 16, or any scraps of dough are scraped off the respective rolls. The scraper 16 of FIG. 1, which is contiguous with the periphery of the discharge roll 3, also facilitates removal of the dough strip strands after cutting by the cutting roll 6.

As depicted in FIGS. 1 through 3, the present level of the dough 30 in the dough feeding device 4 or the dough funnel can optionally be reported by a filler level sensor 18. If the level of the dough climbs too high, the dough feeding device 4 can be halted and any build-up and/or undesired misshaping or pressure exertion on the dough 30 can be prevented.

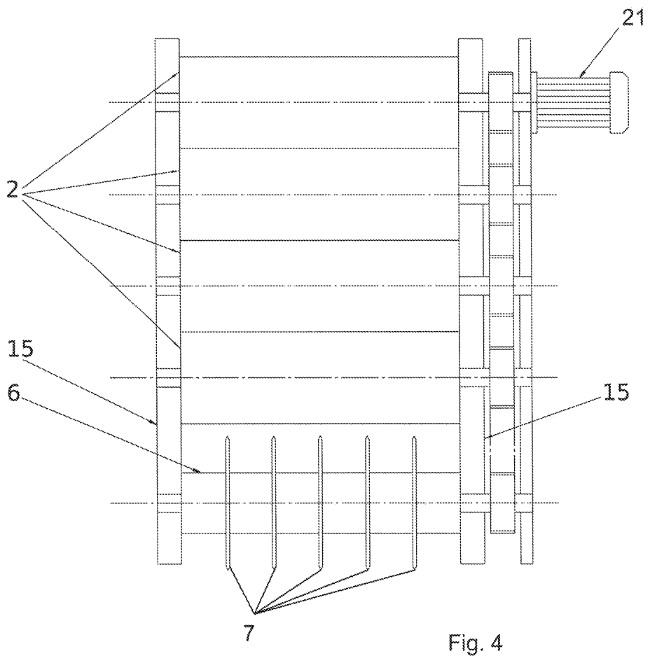

FIG. 4 shows a lateral view of the device 10 according to FIG. 3 facing the periphery of one of the rows of shaping rolls 2. The shaping rolls 4 are each mounted on the front ends in the lateral coverings 15. The device 10 further comprises a drive 21, which is connected with the shaping rolls 2 by toothed wheels. The shaping rolls are each powered uniformly with one another by the drive 21, wherein the toothed wheels between the shaping rolls 2 transmit the rotary movement to the respective next one. The cutting roll 6 is likewise connected by a toothed wheel with the shaping rolls 2 or with the drive. The rotation speed of the shaping rolls 2 of the discharge roll 3 and of the cutting roll 6 can be identical or optionally different. The cutting disc 6 comprises five cutting knives 7, which are configured in disc form and extend to the periphery of the discharge roll 3 (FIG. 3). The lateral coverings 15 delimit the dough chamber 5 laterally and thus determine the width of the dough strip. The dough strip in the embodiment of FIGS. 3 and 4 is cut in uniformly wide dough strip strands, whose width is determined by the distance of the cutting knives 7 from one another or the lateral coverings 15.

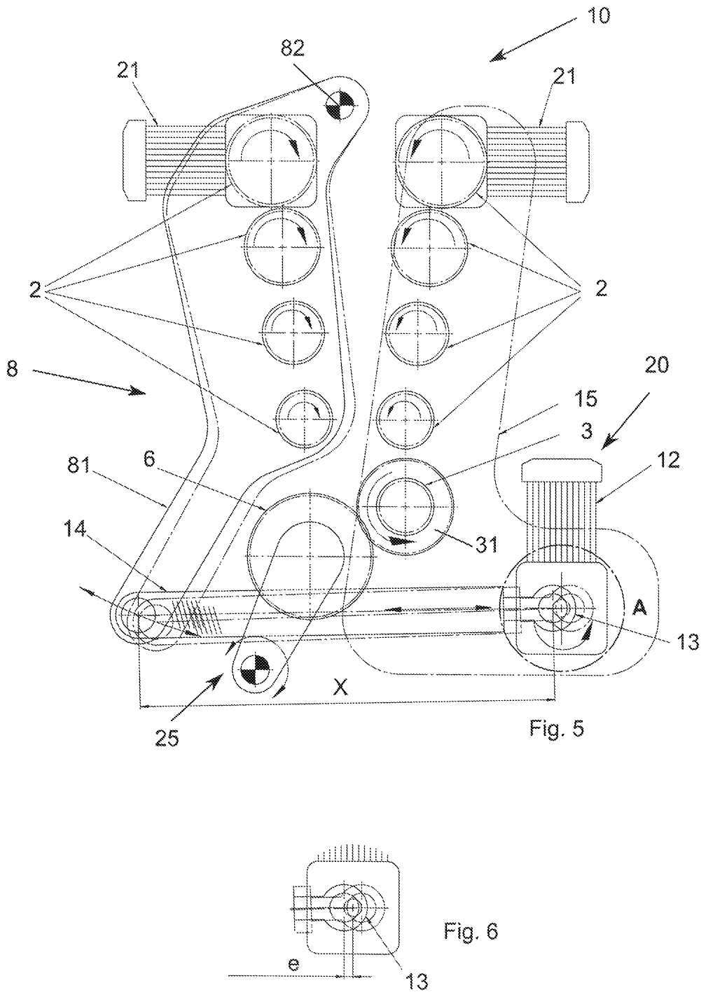

FIG. 5 shows an additionally optional embodiment of the inventive device 10 with a view toward the front ends of the rolls. The device 10 comprises eight shaping rolls 2, each in two rows of four shaping rolls 2, which delimit the dough chamber laterally or are arranged on the same side in relation to the thickness of the dough strip. The shaping rolls 2 are each arranged at a distance from the neighboring one so that they are distanced at their periphery. The shaping rolls 2 comprise different diameters, so that the diameter of the shaping rolls 2 decrease from the entry of the dough chamber to the outlet of the dough chamber 5. The two rows of shaping rolls 2 are arranged in funnel shape toward one another, so that the distance between the axes of the shaping rolls 2 arranged at the same height in the dough chamber 5 tapers in each case from the entry into the dough chamber 5 as far as the outlet. The device 10 comprises two drives 21, which are configured as motors. The two drives 21 each power the shaping rolls 2 of the respective side of the dough chamber 5 together. The discharge roll 3 is configured as a counter-roll for the lateral roll 6, wherein the cutting knives 7 of the cutting roll 6 extend all the way to the discharge roll 3. The cutting knives 7 comprise a greater cutting depth than the shaped dough strip, so that the dough strip undergoes no misshaping between the discharge roll 3 and the cutting roll 6.

The device 10 comprises a pivot element 8, with which the four shaping rolls 2 that, each seen on a common side of the dough chamber with respect to the thickness of the dough strip, are arranged on the same side, can be pivoted, or displaced in the direction of the thickness of the dough strip. The distance of the axes of the shaping rolls 2, which are connected with the pivot element 8, is thereby displaced to the axes of all other shaping rolls 2 not connected with the pivot element 8. The thickness of the dough strip can be modified and preset thereby.

The pivot element 8 comprises two pivot levers 8 arranged parallel to one another in the direction of the width of the dough chamber 5. The four shaping rolls 2, that, each seen on a common side of the dough chamber with respect to the thickness of the dough strip, are arranged on the same side, are mounted on the pivot levers 81. Upon pivoting of the pivot lever 8, the distance of the axes of the shaping rolls 2, which are mounted in the pivot lever 81, from the respective other shaping rolls 2 not mounted in the pivot lever 81, arranged jointly on the other side of the dough chamber, can be displaced and/or adjusted.

The pivot element 8 further comprises a pivot drive 20, which includes an electric motor 12. Connected with the electric motor 12 is an eccentric mechanism 13, with a defined eccentricity 3 (FIG. 6), which rotates with the motor 12 in operation. Arranged between the eccentric mechanism 13 and the pivot lever 81 is a control element 13, configured as a hydraulic cylinder 14. The hydraulic cylinder 14 is connected at one end on the piston on the eccentric mechanism 13 and at the other end or with the housing on the pivot lever 81. If the eccentric mechanism 13 is powered by the motor 12, the pivot lever 81 is pivoted by the hydraulic cylinder 14 oscillating about the pivot axis 82 by a pre-defined value. By means of the oscillating pivoting movement of the pivot axis 81 in the dough strip production process, the dough quality of the dough strip is improved and the quality of the cuts of the dough strip into dough strip strands is improved.

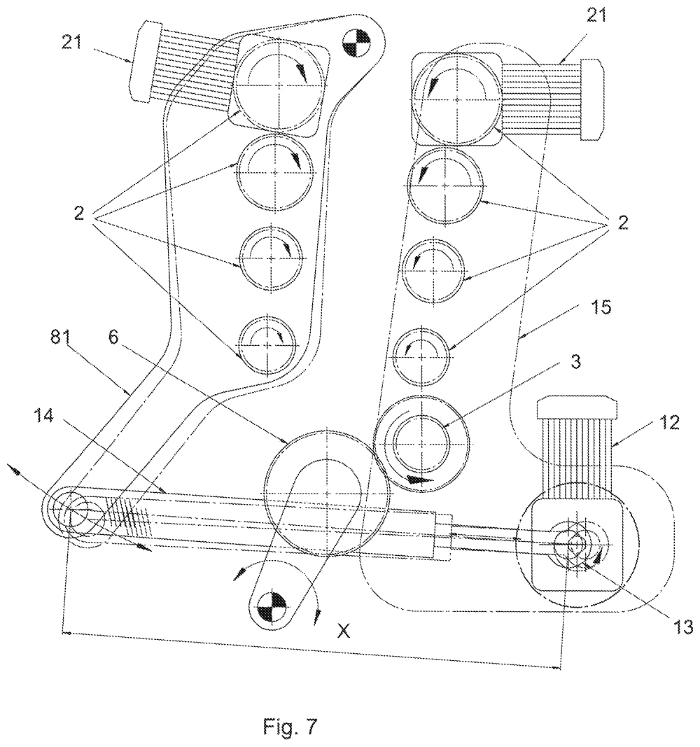

Optionally, as depicted in FIGS. 5 and 7, the control means can be configured for lengthwise adjustability. Thus, the hydraulic cylinder 14 can be inserted or removed by applying pressure, electric power, or control signals, whereby the distance X and thereby the distance of the axes of the shaping rolls 2 affixed to the pivot lever 81 from the shaping rolls 2 not affixed to the pivot lever 81 or to the pivot device 8, can be modified. In FIG. 5 the device 10 is depicted with a small distance X and in FIG. 7 with a great distance X. Upon modifying the distance X, the thickness of the dough strip can be altered or the device 10 can be brought into a cleaning position in which the individual rolls and the dough chamber 5 are accessible by simple means and thus can be cleaned easily.

Alternatively, the control element, rather than as hydraulic cylinder 14, can also be configured as a linear element, spindle gears, etc., so that the distance of the axes of the shaping rolls can be modified by displacing the linear element, spindle gear, etc.

The cutting roll 6 is arranged on a displacement device 25. The displacement device 25 is configured as a pivot arm 26 that can move about an axis, by which the distance and/or the pressure force of the cutting roll 6 on the discharge roll 3 can be adjusted.

Alternatively, it can be foreseen that the pivot drive 20 is configured pneumatically or electrically or electromechanically.

Optionally, the discharge roll 3 or the cutting roll 6 can comprise two lateral walls 31 (FIG. 6), each of which is arranged in the area of an end of the discharge roll 3 and/or of the cutting roll 6. The lateral walls 31, in cutting the dough strip with the cutting roll 6, make it possible to prevent misshaping and a deflection of the dough strip and can cause a clean cutting shape.

In another option, the shaping rolls 2 and/or the discharge roll 3 and/or the cutting roll 6 can have a different profile, wherein in particular the shaping rolls 3 comprise a profiled periphery and the discharge roll 3 and the cutting roll 6 are of smooth configuration.

Optionally it can be foreseen that the control element, in particular the hydraulic or pneumatic cylinder 14 or the linear elements or the spindle gears, comprise a sensor system. The current length of the control element is recorded by means of the sensor system. By the sensor system, then, the length of the control element and thus the thickness of the dough strip can be set or modified on the basis of previously determined or entered weights of the dough pieces.

1. A device for shaping several dough strip strands, including
a dough feeding device by which dough can be introduced into the device,
at least two shaping rolls which can rotate about their axes,
as well as at least one discharge roll which can rotate about its axis and
at least one drive with which the shaping rolls and/or the discharge roll can be powered about their axes,
wherein the axes of the shaping rolls and discharge roll are arranged parallel to one another at a distance and a dough chamber is configured between the shaping rolls and the discharge roll,
wherein the device comprises two lateral coverings, which delimit the dough chamber laterally,
wherein two of the shaping rolls are arranged in the area of the dough feeding device at a distance to one another, so that dough can be inserted from the dough feeding device onto the periphery of the first shaping roll and by rotating the two shaping rolls close to the dough feeder device can be inserted into the dough chamber, and
wherein the device comprises a dough delivery device, which is downstream from the discharge roll and the shaped dough strip can be extracted from the device by the dough delivery device,
wherein the device includes a cutting roll, which is powered and is arranged inside the dough chamber,
wherein one of the shaping rolls or the cutting roll is arranged with the discharge roll at a distance from one another in such a way that dough can be configured between one of the shaping rolls or the cutting roll and the discharge roll having a defined thickness, as shaped dough,
wherein the cutting roll includes a number of cutting knives, which extend as far as the outer periphery of the discharge roll and wherein the cutting roll is arranged with the discharge roll in the area of the outlet of the dough chamber in such a way that the cutting knives divide the dough strip shaped in the dough chamber along the width of the dough strip into a number of dough strip strands.

2. The device according to claim 1, wherein the discharge roll is configured as a counter-roll for the cutting roll, wherein the cutting knives of the cutting roll extend as far as the discharge roll, wherein the cutting knives include a greater cutting depth than the shaped dough strip, so that the dough strip undergoes no misshaping between the discharge roll and the cutting roll.

3. The device according to claim 1, wherein the device includes a pivot device, wherein a number of the shaping rolls, seen on a common side of the dough chamber from the viewpoint of the thickness of the dough strip, are arranged on the same side and/or the discharge roll is connected with the pivot device and can pivot by means of the pivot device in the direction of the thickness of the dough strip, wherein the distance of the axes of the shaping rolls and/or of the discharge roll that are connected with the pivot device is adjustable to the axes of at least one of the respective other shaping rolls not connected with the pivot device and/or of the discharge roll and in this manner the thickness of the dough strip can be modified and/or preset.

4. The device according to claim 3, wherein the pivot device includes two pivot levers arranged parallel to one another, wherein one of the pivot levers can be pivoted about a pivot axis, and wherein the mounting of a number of the shaping rolls, each seen on a common side of the dough chamber with respect to the thickness of the dough strip, are arranged on the same side, and/or the discharge roll is arranged in both pivot levers, wherein upon pivoting of the pivot levers the distance of the axes of the shaping rolls, which are mounted in the pivot levers, and/or of the discharge roller from the respective other shaping rolls not mounted in the pivot levers is displaceable and/or adjustable.

5. The device according to claim 1, wherein the device includes a pivot drive, wherein the pivot drive is arranged and configured in such a way that a number of shaping rolls, each seen on a common side of the dough chamber with respect to the thickness of the dough strip, are arranged on the same side, and/or the discharge roll oscillating in the direction of the thickness of the dough strip can be powered around a neutral point, so that the distance of the axes of the shaping roll and/or of the discharge roll that, oscillating by the pivot drive, are movable to the axes of at least one of the respective other shaping rolls not powerable by the pivot drive and/or to the axis of the discharge roll oscillating in the dough production process are displaced by a preset distance.

6. The device according to claim 4, wherein the pivot device includes a displaceable control unit, wherein the pivot drive comprises an eccentric mechanism powerable by a motor, wherein the control element is connected at one end with the pivot lever and at the other end with the eccentric mechanism, wherein the pivot lever with motor drive can be pivoted about the pivot axis by the eccentric mechanism and control element oscillating about a neutral point.

7. The device according to claim 1, wherein the cutting roll is arranged on a displacement device, wherein the distance and/or the pressure force of the cutting roll can be adjusted on the discharge roll by the displacement device, wherein the displacement device is configured as a pivot arm moveable about an axis on which the cutting roll is arranged.

8. The device according to claim 1, wherein the discharge roll and/or the cutting roll includes two lateral walls, which each are arranged in the area of the end of the discharge roll and/or cutting roll, wherein the lateral walls are arranged and configured in such a way that, in cutting the dough strip with the cutting roll, misshaping and a deviation of the dough strip are prevented.

9. The device according to claim 1, wherein the device includes a number of scrapers, wherein the scrapers are each contiguous with the periphery of a shaping roll, wherein dough can be removed from the periphery of the respective shaping roll by means of the scrapers.

10. The device according to claim 1, wherein the device includes a number of milling devices and/or a number of spray elements, wherein the milling devices and/or spray elements are arranged in the device in a manner to prevent adherence of dough on surfaces of the device that are in contact with dough.

11. The device according to claim 1, wherein the dough feeding device includes a filler funnel and at least one filler level sensor, wherein the filler level of the dough feeding device, particularly of the filler funnel, can be determined by means of the filler level sensor.

12. The device according to claim 1, wherein the device includes a number of drives, wherein the shaping roll and/or the discharge roll, together or separately, can be driven, preferably at different RPM speeds,
or that the device includes two drives, wherein in each case the shaping rolls, that, each seen on a common side of the dough chamber with respect to the thickness of the dough strip, are arranged on the same side, are each powered jointly by one of the two drives and are connected with one another.

13. The device according to claim 1, wherein the shaping rolls and/or the discharge roll and/or the cutting roll have different profiling, wherein the shaping rolls have a profiled periphery and the discharge roll and cutting roll are of smooth configuration.

14. The device according to claim 1, wherein the cutting roll is arranged replaceably on the device.

15. The device according to claim 6, wherein the control element has a sensor system, by which the current length of the control element can be ascertained, wherein by the sensor system the length of the control element and thus the thickness of the dough strip can be adjusted on the basis of previously determined or entered weights of the dough pieces.
